(19) United States
(12) Patent Application Publication
(10) Pub. No.: US 2008/0113439 A1
(43) Pub. Date: May 15, 2008

(54) METHOD FOR PREDICTING CATALYST PERFORMANCE

(76) Inventors: James Roy Butler, League City, TX (US); Xin Xiao, Houston, TX (US)

Correspondence Address: FINA TECHNOLOGY INC, PO BOX 674412, HOUSTON, TX, 77267-4412, US

(21) Appl. No.: 11/560,133

(22) Filed: Nov. 15, 2006

(51) Int. Cl. G01N 31/10

(52) U.S. Cl. 436/37

(57) ABSTRACT

A method of predicting the catalytic performance of a multi-site catalyst comprising reducing a control catalyst of known catalytic performance as a function of temperature, quantifying the different catalyst sites in the control catalyst to determine a ratio of desirable catalyst sites to undesirable catalyst sites, reducing a sample catalyst of unknown catalytic performance as a function of temperature, quantifying the different catalyst sites in the sample catalyst to determine a ratio of desirable catalyst sites to undesirable catalyst sites, and comparing the ratio desirable catalyst sites to undesirable catalyst sites in the control catalyst to the ratio of desirable catalyst sites to undesirable catalyst sites in the sample catalyst.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This disclosure relates generally to a method of catalyst selection. More specifically, this disclosure relates to an improved methodology for predicting and/or characterizing the performance of a multi-component catalyst.

Various industrial processes are utilized to convert hydrocarbons such as crude oil to more useful products. Such processes employ a variety of chemical reactions ranging from reforming to alkylation and are typically carried out in the presence of a catalyst such as a transition metal. Such transition metals may form complexes that efficiently carry out the desired reaction. However, the quality and performance of a catalyst can vary between manufacturers and between batches produced by the same manufacturer. For example, in the case of supported catalysts, the catalyst performance may depend upon the support structure which may vary between commercially available catalysts. In many instances, the catalyst is comprised of more than one transition metal complex and each complex may exhibit a differing degree of catalytic activity. For example, a catalyst may be comprised of transition metal complexes represented as MX, MX₂ and MX₃. However, only MX₂ may be capable of catalyzing the desired reaction while the other species have no effect on the reaction. Alternatively, MX and MX₂ may be capable of catalyzing the desired reaction while MX₃ may catalyze an unwanted reaction. In the first instance, the catalyst performance depends on the level of MX₂ in the catalyst sample. In the second, the catalyst performance would depend on the ratio of catalytically desirable species (MX and MX₂) to catalytically undesirable species (MX₃). Also for example, for a supported catalyst, the catalyst performance may additionally depend on the support structure which may vary among the commercially available catalysts. A commonly employed method of identifying different catalytic species in a multi-component catalyst is temperature programmed reduction (TPR).

In TPR the catalyst is submitted to a programmed temperature rise in the presence of a reducing agent. As the catalyst metal active sites are reduced the reducing agent is consumed. The consumption of the reducing agent may be continuously monitored using devices such as thermal conductivity detectors (TCD) and mass spectrometers (MS). The type of information obtainable using TPR may include the temperature range of consumption of reducing agent, temperatures of rate reduction maxima and, the total consumption of reducing agent.

TPR on a supported catalyst can provide information on metal-support interaction and on metal activity during reduction. TPR also can help to identify problems related to catalysts with reducible metals. However, TPR is limited to the identification of differing sites in a catalyst in a multi-component catalyst. Considering the potential impact each component in a multi-component catalyst may have on the overall activity of the catalyst it would be desirable to develop a methodology for predicting the catalytic performance of a multi-component catalyst.

### BRIEF SUMMARY OF SOME OF THE EMBODIMENTS

Disclosed herein is a method of predicting the catalytic performance of a multi-site catalyst comprising reducing a control catalyst of known catalytic performance as a function of temperature, quantifying the different catalyst sites in the control catalyst to determine a ratio of desirable catalyst sites to undesirable catalyst sites, reducing a sample catalyst of unknown catalytic performance as a function of temperature, quantifying the different catalyst sites in the sample catalyst to determine a ratio of desirable catalyst sites to undesirable catalyst sites, and comparing the ratio desirable catalyst sites to undesirable catalyst sites in the control catalyst to the ratio of desirable catalyst sites to undesirable catalyst sites in the sample catalyst.

Also disclosed herein is a method of distinguishing different catalyst sites in a multi-site catalyst comprising contacting a control nickel mordenite catalyst of known catalytic performance with a reducing agent as a function of temperature, determining a ratio of desirable nickel active sites to undesirable nickel active sites in the control nickel mordenite catalyst, contacting a sample nickel mordenite catalyst of unknown catalytic performance with a reducing agent as a function of temperature, determining the ratio of desirable nickel active sites to undesirable nickel active sites in the sample nickel mordenite catalyst, and comparing the ratios of desirable nickel active sites to undesirable nickel active sites in the sample nickel mordenite catalyst to the control nickel mordenite catalyst.

Further disclosed herein is a method of distinguishing different catalyst sites in a multi-component catalyst comprising contacting a control catalyst of known catalytic performance with a reagent wherein the reagent exhibits a different reactivity with each component of the multi-component catalyst, evaluating the relative reactivity of each component of the control catalyst with the reagent, establishing a threshold value for an acceptable performance of a catalyst based on the relative reactivity of each component of the control catalyst with the reagent, contacting a sample catalyst of unknown catalytic performance with a reagent wherein the reagent exhibits a different reactivity with each component of the multi-component catalyst, and evaluating the relative reactivity of each component of the sample catalyst in relation to the threshold value.

The foregoing has outlined rather broadly the features and technical advantages in order that the detailed description that follows may be better understood. Additional features and advantages will be described hereinafter that form the subject of the claims of the invention. It should be appreciated by those skilled in the art that the conception and the specific embodiments disclosed may be readily utilized as a basis for modifying or designing other structures for carrying out the same purposes. It should also be realized by those skilled in the art that such equivalent constructions do not depart from the spirit and scope as set forth in the appended claims.

### BRIEF DESCRIPTION OF THE DRAWINGS

For a detailed description, reference will now be made to the accompanying drawings in which:

FIG. 1 is flowchart of a method for predicting the catalytic performance of a multi-component catalyst;

FIG. 2 is a thermogram of a nickel mordenite catalyst run under typical temperature programmed reduction conditions;

FIG. 3 is a thermogram of a nickel mordenite catalyst run under modified temperature programmed reduction conditions;

FIG. 4 displays thermograms for the samples from Example 1;

FIG. 5 displays thermograms for the samples from Example 2; and

FIGS. 6 and 7 display thermograms for the samples from Example 3.

### DETAILED DESCRIPTION OF THE EMBODIMENTS

Disclosed herein are methods of predicting the performance of a multi-component catalyst. In an embodiment, a methodology for predicting the performance of a multi-component catalyst comprises contacting a control catalyst having a known performance with a reducing agent as a function of temperature and determining the ratio of desirable active sites to undesirable active sites. The procedure may then be repeated using a sample catalyst of unknown catalytic performance. Finally, a comparison of the ratio of undesirable to desirable active sites in the control catalyst as compared to the sample catalyst may allow for a prediction of the catalytic performance of the sample catalyst. Herein catalyst performance may be evaluated by one skilled in the art based on criteria such as the catalyst selectivity and/or efficiency. Herein predicting the catalytic performance of the sample catalyst may involve identifying a threshold value for catalyst performance based on the performance of a control catalyst and evaluating whether the sample catalyst meets said threshold value.

In an embodiment, a methodology for the prediction of catalyst performance employs a catalyst comprising a metal. Such metals are well known in the art and include without limitation Group IB-Group VIIIB (old IUPAC notation) transition metals. Alternatively, the catalyst comprises nickel, platinum, palladium, iron, zirconium, vanadium or combinations thereof. In an embodiment, the catalyst is supported; alternatively, the catalyst is unsupported. Typical catalyst supports include without limitation talc, inorganic oxides, clays and clay minerals, ion-exchanged layered compounds, diatomaceous earth compounds, zeolites, a resinous support material, or combinations thereof.

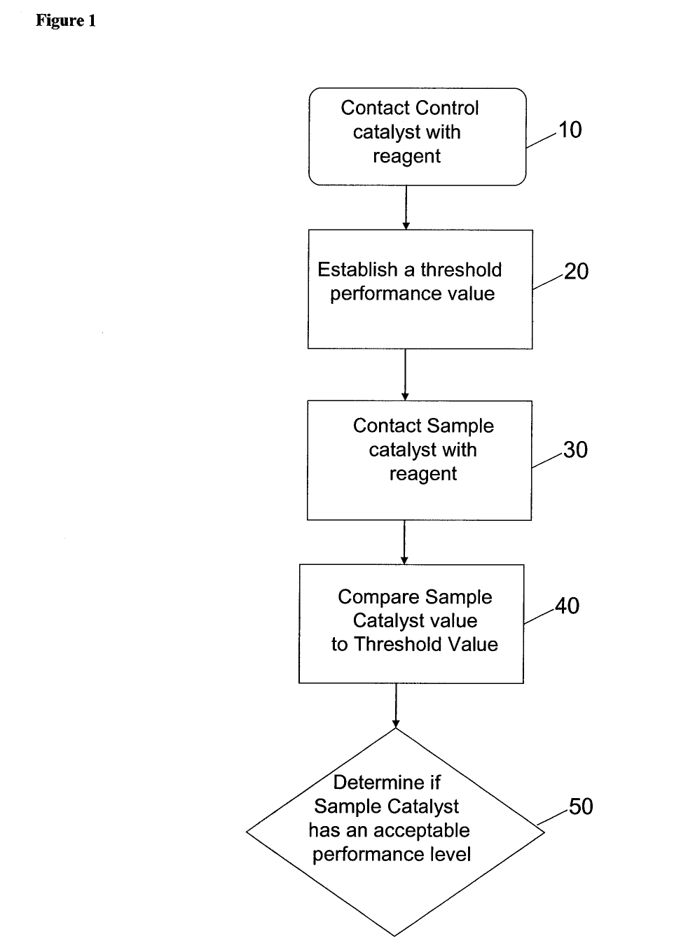

An embodiment of a method for predicting the performance of a multi-component catalyst is set forth in FIG. 1. Herein a multi-component catalyst refers to a catalyst comprising more than one potentially catalytic species. Such species may be for example metal species that differ by the nature of the metal and/or by the nature of the coordinating ligands. Referring to FIG. 1, the method may initiate with block 10 wherein a multi-component catalyst having a known catalytic performance is contacted with a reagent. Hereafter the multi-component control catalyst having a known catalytic performance will be referred to as the MCC. In an embodiment, each component of the MCC reacts with the contacting reagent to produce a unique signal. In some embodiments, the reagent may be a reducing agent and the MCC may be contacted with the reducing agent as a function of temperature. The contacting of the MCC with a reducing agent as a function of temperature may be carried out using any means known to one of ordinary skill in the art. Alternatively, the contacting of the MCC with a reducing agent may be carried out using the process of temperature programmed reduction (TPR).

In an embodiment, a methodology for the prediction of catalyst performance employs TPR. In TPR a catalyst is submitted to a programmed temperature rise under a flow of reducing gas mixture and the consumption of the reducing agent is continuously monitored. Typically, the catalyst is placed in a reactor system equipped with a programmable furnace. The catalyst may then be exposed to a continuous flow of inert or reactive gas mixture, while the temperature is raised according to a predetermined program. The sample temperature and the outlet gas composition are continuously monitored. The consumption of reducing agent may be monitored by any means known to one of ordinary skill in the art such as for example through the use of detectors designed to measure the reducing agent concentration. Examples of detectors for TPR include without limitation thermal conductivity detectors (TCD) and mass spectrometers (MS). The TPR experiment results in the consumption of the reducing agent as a function of temperature, which may be plotted to produce a graph generally termed a thermogram. Multiple reduction rate maxima appearing in a thermogram are commonly attributed to the occurrence of a multi-step reduction mechanism or to multiple reducing species.

In an embodiment, TPR may be carried out in a temperature range of from −100° C. to 1300° C., alternatively from 0° C. to 900° C., alternatively from ambient to 850° C. using a temperature variation rate of from 0.1° C./min to 100° C./min, alternatively from 1° C./min to 20° C./min, alternatively from 5° C./min to 20° C./min at ambient pressure. In alternative embodiments, the TPR may be carried out at pressures ranging from 0 to 100 psia, alternatively from 1 to 50 psia, alternatively from 10 to 20 psia. In an embodiment, TPR may be carried out such that the sample signal to noise ratio is equal to or greater than 2, alternatively equal to or greater than 10, alternatively equal to or greater than 100. Examples of reducing agents suitable for use in TPR include without limitation reducing gases such as hydrogen, carbon monoxide, hydrogen sulfide and combinations thereof. Alternatively, such reducing gases may be used as mixtures with inert gases such as argon, helium, nitrogen and others as known to one of ordinary skill in the art. During TPR, as the temperature is varied, differing components of the MCC may be reduced and the information generated used to determine the type, amount and number of components in the MCC.

In an embodiment, the TPR method may be modified to maximize the signal to noise ratio. As will be understood by one of ordinary skill in the art, numerous factors influence the signal to noise ratio including for example, the amount of sample and the reducing agent used. In an embodiment, the TPR method may be modified to maximize the signal to noise ratio by any means known to one of ordinary skill in the art. Alternatively, within the limits of the instrumentation, the TPR method may be modified by maximizing the amount of sample used, minimizing the flow rate of the carrier gas, minimizing the amount of reducing gas present in the carrier gas to less than 50%, alternatively less than 20%, and further alternatively less than 5%, and maintaining a ratio of inert gas:reducing gas in the carrier mixture of 1:1, alternatively 4:1, and further alternatively 20:1. Without wishing to be limited by theory, the combination of these modifications may result in a signal to noise ratio sufficient to distinguish the components of the MCC of this disclosure.

In addition, the signal to noise ratio of the TPR may be improved by pre-treating the MCC prior to carrying out TPR in order to maximize the TPR signal. Such pre-treatments are known to one of ordinary skill in the art and include for example oxidation of the MCC. In an embodiment, the MCC is dried and/or pre-oxidized prior to carrying out the TPR. The pre-oxidation may be carried out under flowing air at a temperature ramp for a period of time. Thereafter, the catalyst may be allowed to return to ambient temperature, again under flowing air. An example of a modified TPR is described in more detail in the comparative example.

In an embodiment, TPR or modified TPR is used to distinguish differing components or sites in a MCC. These sites may be further characterized as desirable or undesirable catalytic sites or components. Herein a desirable catalytic site or component is one that accelerates the reaction desired by the user whereas an undesirable catalytic site may function to accelerate said reaction to a lesser extent, to accelerate an unwanted reaction or otherwise detract from the user desired reaction. Characterization of a site as desirable or undesirable may be made by one of ordinary skill in the art based on any number of factors including but not limited to the expected or known architecture of a desirable catalytic site, the expected or known reduction potential of a desirable catalytic site and the expected or known amount of a desirable catalytic site in the MCC.

Referring to FIG. 1, in an embodiment, following contacting the control catalyst with a reagent as disclosed herein, the method proceeds to block 20 and a threshold value for acceptable catalytic performance is established. In an embodiment, the threshold value for catalytic performance may be established by calculating the ratio of desirable to undesirable catalytic sites or components in the MCC. This ratio of desirable to undesirable catalytic sites for the MCC may be referred to hereafter as the r-MCC. Without wishing to be limited by theory, the performance of the MCC appears to be dependent on having a sufficient number of desirable catalytic sites to outweigh any negative effects due to the presence of undesirable catalytic sites. As such, the r-MCC may be used to establish a minimum value for acceptable catalytic performance.

Referring to FIG. 1, the method may then proceed to block 30 and a multi-component sample catalyst of unknown catalytic performance is contacted with the reagent. Hereafter the multi-component sample catalyst having an unknown catalytic performance will be referred to as the MSC. In an embodiment, each component of the MSC reacts with the contacting reagent to produce a unique signal. In an embodiment, the reagent is a reducing agent as previously described and the MSC is contacted with the reducing agent as a function of temperature via TPR as previously disclosed herein. In an embodiment, TPR is used to distinguish differing components or sites in a MSC. The information obtained from TPR analysis of the MSC may then be used to determine the ratio of desirable to undesirable catalytic sites in the MSC using the methodology disclosed herein for determination of the ratio of desirable to undesirable catalytic sites for the MCC. This ratio of desirable to undesirable catalytic sites for the MSC may be referred to hereafter as the r-MSC. In an embodiment, the method may then proceed to block 40 and the r-MSC is compared to the r-MCC. The method may terminate with block 50 wherein based on the comparison of the r-MSC to the r-MCC the catalytic performance of the MSC may be predicted to be acceptable or unacceptable. In an embodiment, where the r-MSC is equal to or greater than the r-MCC, the MSC is deemed to have an acceptable performance level. Likewise, where the r-MSC is less than the r-MCC, the MSC is deemed to have an unacceptable performance level.

In an embodiment, the methodology disclosed herein for predicting the performance of a multi-component catalyst may be employed to predict the performance of a toluene disproportionation (TDP) catalyst. Various petroleum refining operations involving the disproportionation of aromatic hydrocarbons, such as TDP, are carried out over a metal modified zeolite disproportionation catalyst. TDP is a commonly utilized refining process involving the disproportionation of toluene in a transalkylation reaction in which toluene is converted to benzene and xylene. The disproportionation reaction, which typically takes place in the presence of molecular hydrogen supplied in addition to the toluene, provides for a stoichiometric relationship in which two moles of toluene are converted to one mole of benzene and one mole of xylene. The catalytic performance of a TDP catalyst may vary between manufacturers and between batches produced by the same manufacturer. In TDP specifically, a low performance catalyst can produce undesirable contaminants or nonaromatics during the TDP reaction. A catalyst commonly employed in TDP is a metal-mordenite supported catalyst.

Mordenite is one of a number of molecular sieve catalysts useful in the conversion of alkylaromatic compounds. Mordenite is a crystalline aluminosilicate zeolite exhibiting a network of silicon and aluminum atoms interlinked by oxygen atoms within the crystalline structure. For a general description of mordenite catalysts, reference is made to Kirk-Othmer, Encyclopedia of Chemical Technology, 3rd Edition, 1981, under the heading “Molecular Sieves”, Vol. 15, pages 638-643, incorporated by reference herein in its entirety.

In an embodiment, a multi-component TDP catalyst is a nickel-mordenite catalyst (NiM). NiM and other TDP catalysts have been described in U.S. Pat. Nos. 4,956,511; 4,761,514; 3,562,345 and 3,677,973, each of which are incorporated by reference herein. In an embodiment, the performance of a sample NiM compound as a TDP catalyst may be predicted using the methodology disclosed herein. In an embodiment, a methodology for predicting the performance of a sample NiM (s-NiM) compound as a TDP catalyst initiates with contacting a control NiM (c-NiM) catalyst of known and acceptable performance as a TDP catalyst with a reducing agent as a function of temperature. Such processes (i.e., TPR) have been previously described herein. The characterization of the performance of the c-NiM as “acceptable” may be made by one of ordinary skill in the art based on any number of user desired results such as for example and without limitation catalyst efficiency, catalyst selectivity and/or catalyst productivity.

In an embodiment, the c-NiM is subjected to TPR at temperatures ranging from −100° C. to 1300° C., alternatively from 0 to 900° C., alternatively from ambient to 850° C. at ambient pressure. The reducing agent may comprise hydrogen, carbon monoxide, hydrogen sulfide combinations thereof or mixtures thereof with inert gases such as nitrogen and argon which may contact the c-NiM at a rate of from 1 ml/min to 100 ml/min, alternatively from 1 ml/min to 20 ml/min, alternatively from 5 ml/min to 20 ml/min. TPR when carried out as described may lead to a signal to noise ratio of equal to or greater than 2, alternatively equal to or greater than 10, alternatively equal to or greater than 100. In an embodiment, the c-NiM when subjected to TPR under the disclosed conditions may generate a thermogram having at least one signal at or below 300° C. and at least one signal at or above 600° C. Without wishing to be limited by theory, NiM may comprise differing TDP catalytic sites corresponding to differences in the extent of incorporation of Ni into the mordenite support. Ni that is incompletely incorporated into the mordenite support may be easier to access and reduce and thus would generate a TPR signal at a lower temperature than Ni that is fully incorporated into the mordenite support. In an embodiment, the signal at or below 300° C. in the NiM corresponds to incompletely incorporated Ni and is an undesirable catalytic site or component for TDP while the signal at or above 600° C. corresponds to incorporated Ni and is a desirable catalytic site or component for TDP. The amount of signal may be quantitated using any means known to one of ordinary skill in the art. In an embodiment, the performance of the c-NiM as a TDP catalyst is evaluated by comparing the ratio of desirable (i.e., signal at or above 600° C.) to undesirable (i.e., signal at or below 300° C.) sites. In an embodiment, a c-NiM having an acceptable level of performance as a TDP catalyst may have a ratio of desirable active sites to undesirable active sites of equal to or greater than 25, alternatively equal to or greater than 50, further alternatively equal to or greater than 75, alternatively equal to or greater than 100. A threshold value for acceptable performance of a NiM as a TDP catalyst may then be established based on a ratio of desirable to undesirable catalytic sites of equal to or greater than 25.

In an embodiment, a sample NiM of unknown catalytic performance (s-NiM) may be predicted to be an acceptable or unacceptable TDP catalyst using the methodology disclosed herein. In an embodiment, the s-NiM is subjected to TPR under the conditions described for the c-NiM and the ratio of undesirable NiM to desirable NiM catalytic sites established. The s-NiM may then be predicted to have an acceptable performance as a TDP catalyst if the ratio of desirable catalytic sites to undesirable catalytic sites is equal to or greater than 25.

The methods described herein may be carried out manually, may be automated, or may be combinations of manual and automated processes. In an embodiment, the method is implemented via a computerized apparatus, wherein the method described herein is implemented in software on a general purpose computer or other computerized component having a processor, user interface, microprocessor, memory, and other associated hardware and operating software. Software implementing the method may be stored in tangible media and/or may be resident in memory, for example, on a computer. Likewise, input and/or output from the software, for example ratios, comparisons, and results, may be stored in a tangible media, computer memory, hardcopy such a paper printout, or other storage device.

### EXAMPLES

The following examples are given to demonstrate the practice and advantages of particular embodiments. It is understood that the examples are given by way of illustration and are not intended to limit the specification of the claims in any manner.

### Comparative Example

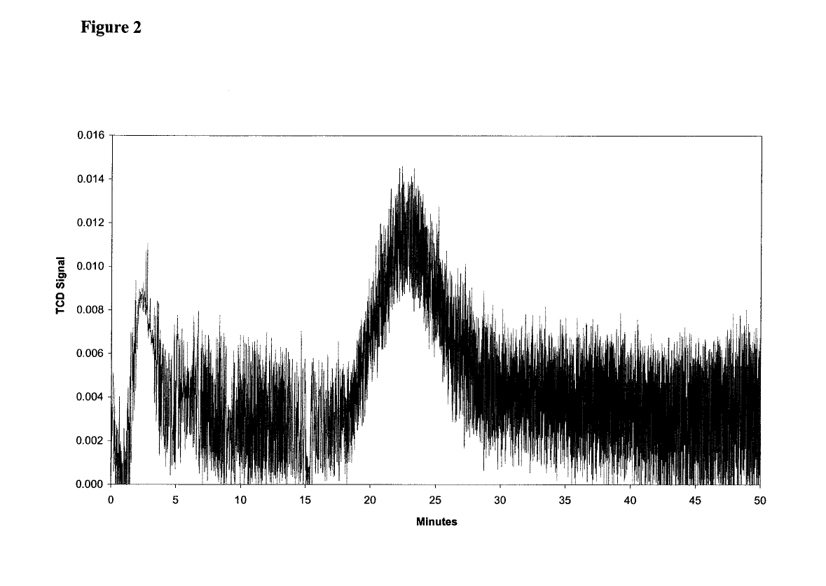

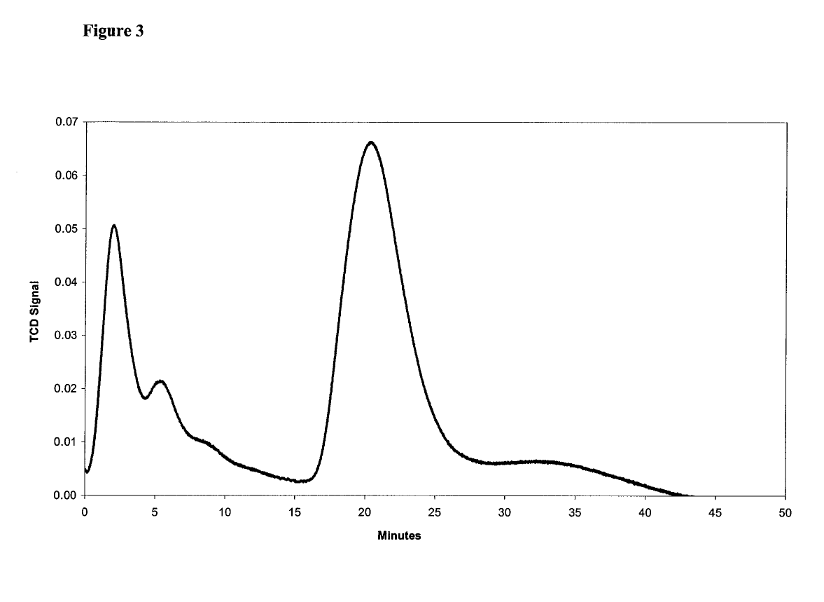

Temperature programmed reduction of a nickel-mordenite catalyst was carried out to identify different sites in the multi-component catalyst. Specifically, TPR was carried out on a MICROMETRICS AutoChem 2910 unit using approximately 1.0 g of catalyst. Typical TPR conditions were 10% H₂ in Argon as the carrier gas at 50 ml/min, temperature ramp at 110° C./min. The thermogram of the catalyst run under typical TPR conditions is shown in FIG. 2 which is a plot of detector signal as a function of time. It is noticed that the detector signal could be easily calibrated and converted to the H₂ concentration in the carrier gas. However, this was not done because information without the calibration was enough to interpret data. The typical TPR conditions were modified and TPR carried out on 1.0 g of a second nickel mordenite sample. The modified TPR procedures involved drying and pre-oxidizing the catalyst by flowing air at a temperature ramp to 550° C. at 20° C./min, and maintaining these conditions for 20 min. The sample temperature was returned to ambient while still under flow of air. The system was then flushed with argon for 20 min, before being switched to the carrier gas, 10% H₂-90% Ar which was contacted with the sample at a rate of 10 ml/min. The reduction was then carried out at by varying the temperature 10° C./min to a maximum temperature of 850° C. and changes in the concentration of reducing agent monitored using a TCD detector. The TCD signal was reported as a function of time and is shown in FIG. 3.

The results demonstrate that a NiM TDP catalyst when subjected to typical TPR conditions has a very low signal to noise ratio, FIG. 2. However using the modified TPR procedure, two signals at equal to or below 300 and equal to or above 650° C. are clearly visible in the thermogram, FIG. 3. The two multiple reduction rate maxima seen in FIG. 3 indicated two species of nickel which, without wishing to be limited by theory, may correspond to unincorporated nickel (at or below 300° C. peak) and incorporated nickel (at or above 650° C. peak).

### Example 1

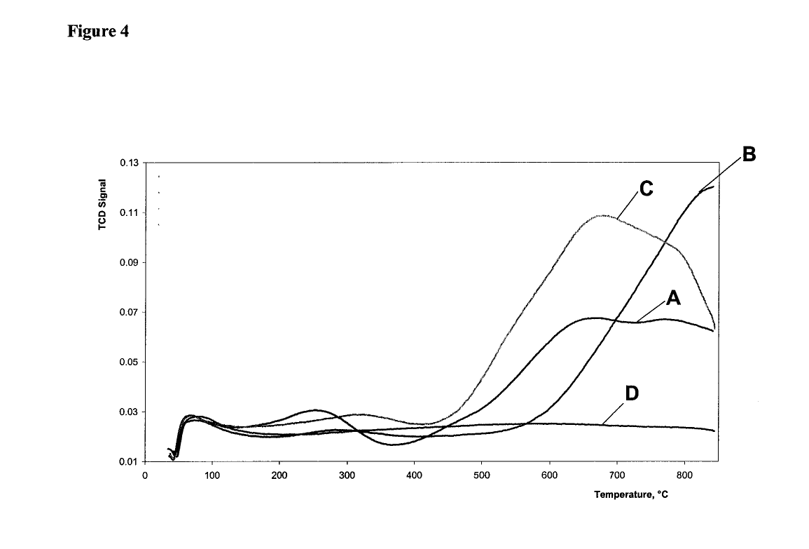

TPR was carried out using the modified conditions described in Comparative Example 1 to characterize the performance of different samples of a TDP catalyst. Specifically, TPR thermograms shown in FIG. 4 of a NiM catalyst, Sample A, was compared with its mordenite extrudate without Ni, Sample D, as well as two lab prepared NiM samples, Samples B and C. Referring to FIG. 4, the small peak below 100° C. is the hydrogen adsorption that exists in all samples. The peak around 270° C. in Samples A, B, and C indicates the existence of easily reducible Ni, which is undesirable because it results in nonaromatic byproducts and exotherms during startup. Specifically, exotherms are the result of the easily reducible Ni sites being reduced to metallic Ni by hydrogen under the TDP reaction conditions. The metallic Ni can efficiently saturate benzene rings via hydrogenation reaction because the lattice of the metallic Ni has an ahnost perfect fit to the six-member ring of a benzene molecule. The hydrogenation reaction is strongly exothermic, resulting in both the generation of a large amount of heat (exotherms) during commercial unit startup and in the production of nonaromatic byproducts.

The mordenite extrudate without Ni does not show any reduction peaks at or below 300° C. or above 600° C. Sample A showed a higher TPR peak at above 600° C. than the two lab prepared samples, Samples B and C. The TPR peak above 600° C. is the reduction peak of the Ni incorporated with mordenite. The Ni within mordenite extends the catalyst life by removing coke without producing nonaromatics. Therefore, the TPR results suggest that Sample A and the two lab samples, Samples B and C would have differences in catalytic performance and illustrates that TPR methodology can be used to distinguish catalyst samples which may have differing levels of performance based on differences in the ratios of desirable to undesirable catalytic sites.

### Example 2

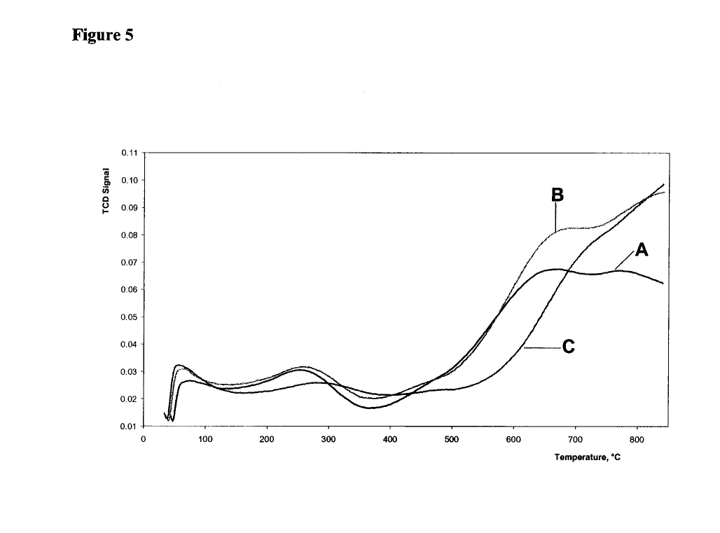

The effects of the post synthesis processing on the catalytic performance of several TDP catalysts (Samples A-C) were assessed by TPR. Sample A is an untreated control sample of NiM, Sample D is the mordenite support in the absence of nickel and Samples B and C were NiM samples that were subjected to post synthesis processing. TPR was carried out using the modified conditions described in Comparative Example 1 on all samples and the thermograms are compared in FIG. 5. Post synthesis processing of Sample B, did not result in a prediction of improved catalytic performance as evinced by the few changes observed in the thermogram of Sample B. Specifically, although the high temperature peak shifted a little in Sample B, the peak at 270° C. was still significant. This peak indicates the existence of easy reducible Ni, which is responsible for nonaromatic byproducts and exotherm during TDP reaction. However, in Sample C, the peak at 270° C. was reduced to a minimum (also shifted to 300° C.) and the 660° C. peak shifted to above 800° C.

### Example 3

TPR was used to analyze NiM samples that exhibited varying performance as TDP catalysts. Specifically, TPR was carried out on six NiM samples, A-E, using the modified TPR conditions described in Comparative Example 1. Sample F is mordenite in the absence of metal.

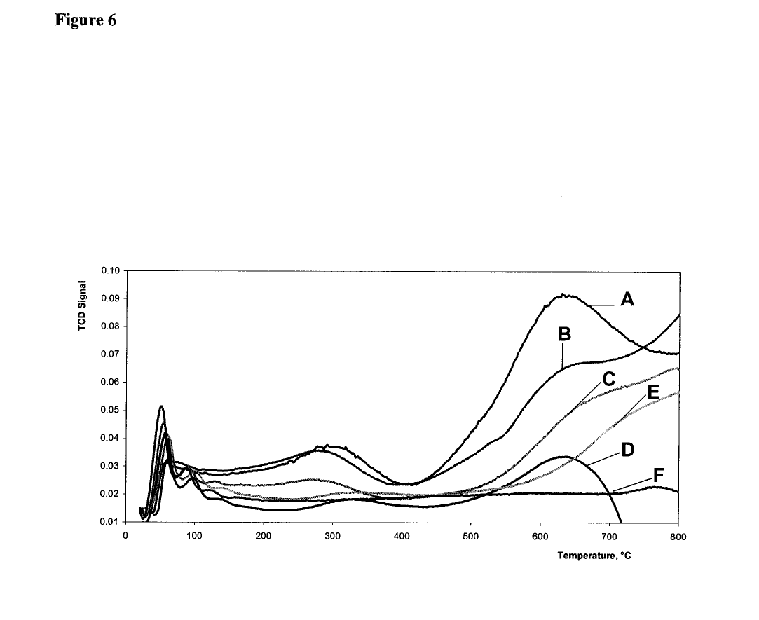

The results are shown in FIG. 6. Specifically, Samples A-E are believed to vary in Ni content. While the variations in Ni content are believed to be small, the different samples exhibited large differences in performance as a TDP catalyst. A small increase of the Ni content negatively impacted the catalyst performance, because the extra Ni lands on the catalyst surface as nickel oxide (NiO) instead of incorporating with the mordenite. The surface NiO is easily reduced to metallic nickel under TDP reaction conditions, which is extremely active for hydrogenation of benzene ring due to its geometry fit to the Ni lattice surface. Each sample, with the exception of Sample F, showed two reduction peaks, one at or below 300° C. and a second at or above 600° C. The undesirable surface NiO was reduced around 300° C. The majority of the Ni was inside the mordenite as cation that was difficult to reduce unless the temperature was above 450° C., normally above 600° C. The TPR results indicated that the surface Ni in Sample A was the highest and correlated with the poorest performance as a TDP catalyst. On the other hand, the surface Ni peaks of the Samples B-E were much lower and these samples showed better performance as TDP catalysts. The catalyst resulted in benzene and mixed xylenes products with minimum nonaromatics. The main products, benzene and mixed xylenes, were on specification for the nonaromatic contents (0.15 wt %) after separated by distillation.

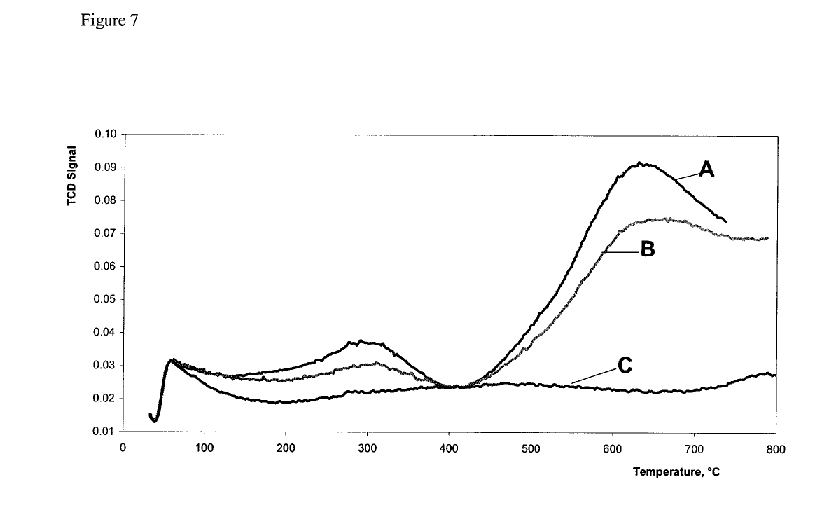

The relative robustness of the NiM catalyst was further investigated by TPR. Specifically, Sample A which showed the highest level of undesirable catalytic sites (i.e., signals at around 270° C.) was a catch sample while Sample B was a composite sample. Both were subjected to TPR analysis. The results of Samples A and B are shown, respectively, in FIG. 7. The TPR of a sample of the mordenite support in the absence of Ni is also shown for comparison in Sample C. The results demonstrate an increase in the peak centered around 270° C. occurred in the catch sample indicting that sample catalytic performance may have variations among batches of the samples.

While embodiments have been shown and described, modifications thereof can be made by one skilled in the art without departing from the spirit and teachings herein. The embodiments described herein are exemplary only, and are not intended to be limiting. Many variations and modifications disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from 1 to 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, comprising, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment. Thus, the claims are a further description and are an addition to the embodiments. The discussion of a reference herein is not an admission that it is prior art, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of predicting the catalytic performance of a multi-site catalyst comprising:
reducing a control catalyst of known catalytic performance as a function of temperature;
quantifying the different catalyst sites in the control catalyst to determine a ratio of desirable catalyst sites to undesirable catalyst sites;
reducing a sample catalyst of unknown catalytic performance as a function of temperature;
quantifying the different catalyst sites in the sample catalyst to determine a ratio of desirable catalyst sites to undesirable catalyst sites; and
comparing the ratio desirable catalyst sites to undesirable catalyst sites in the control catalyst to the ratio of desirable catalyst sites to undesirable catalyst sites in the sample catalyst.

2. The method of claim 1 further comprising establishing an acceptable level for catalyst performance based on the ratio of desirable catalyst sites to undesirable catalyst sites in the control catalyst.

3. The method of claim 2 further comprising evaluating whether the sample catalyst has an acceptable catalyst performance level.

4. The method of claim 1 wherein the catalyst reduction as a function of temperature is carried out using temperature programmed reduction.

5. The method of claim 4 wherein the temperature programmed reduction is carried out in the presence of both a carrier gas and a reducing gas wherein the carrier gas comprises a mixture of an inert gas and a reducing gas.

6. The method of claim 5 wherein the carrier gas comprises less than 50% of the reducing gas and the ratio of reducing gas to inert gas in the carrier gas is 1:1.

7. The method of claim 5 wherein the reducing gas comprises hydrogen, carbon monoxide, or combinations thereof.

8. The method of claim 4 wherein the temperature programmed reduction is carried out in a temperature range of from −100° C. to from 900° C.

9. The method of claim 4 wherein the temperature programmed reduction is carried out at a rate of from 0.1° C./min to from 100° C./min.

10. The method of claim 4 wherein the temperature programmed reduction is characterized by establishing a signal to noise ratio of equal to or greater than 2.

11. The method of claim 4 wherein the temperature programmed reduction is carried out in a pressure range of from sub-atmospheric to equal to or greater than 1 bar.

12. The method of claim 4 wherein the temperature programmed reduction occurs in the presence of a reducing agent and wherein the reducing agent comprises hydrogen, carbon monoxide, or combinations thereof.

13. The method of claim 1 wherein the catalyst comprises a metal.

14. A method of distinguishing different catalyst sites in a multi-site catalyst comprising:
contacting a control nickel mordenite catalyst of known catalytic performance with a reducing agent as a function of temperature;
determining a ratio of desirable nickel active sites to undesirable nickel active sites in the control nickel mordenite catalyst;
contacting a sample nickel mordenite catalyst of unknown catalytic performance with a reducing agent as a function of temperature;
determining the ratio of desirable nickel active sites to undesirable nickel active sites in the sample nickel mordenite catalyst; and
comparing the ratios of desirable nickel active sites to undesirable nickel active sites in the sample nickel mordenite catalyst to the control nickel mordenite catalyst.

15. The method of claim 14 wherein the nickel mordenite catalyst when reduced as a function of temperature has a signal at 300° C., 600° C., or both.

16. The method of claim 15 wherein the 300° C. signal corresponds to an undesirable nickel site.

17. The method of claim 15 wherein the 600° C. signal corresponds to a desirable nickel site.

18. The method of claim 14 further comprising establishing an acceptable level for catalyst performance based on the ratio of desirable catalyst sites to undesirable catalyst sites in the control nickel mordenite catalyst.

19. The method of claim 18 further comprising evaluating whether the sample nickel mordenite catalyst has an acceptable catalyst performance level.

20. The method of claim 14 wherein the control nickel mordenite catalyst has a ratio of desirable active sites to undesirable active sites of equal to or greater than 25.

21. A method of distinguishing different catalyst sites in a multi-component catalyst comprising:
contacting a control catalyst of known catalytic performance with a reagent wherein the reagent exhibits a different reactivity with each component of the multi-component catalyst;
evaluating the relative reactivity of each component of the control catalyst with the reagent;
establishing a threshold value for an acceptable performance of a catalyst based on the relative reactivity of each component of the control catalyst with the reagent;
contacting a sample catalyst of unknown catalytic performance with a reagent wherein the reagent exhibits a different reactivity with each component of the multi-component catalyst; and
evaluating the relative reactivity of each component of the sample catalyst in relation to the threshold value.
